(19) United States
(12) Patent Application Publication
(10) Pub. No.: US 2017/0087769 A1
(43) Pub. Date: Mar. 30, 2017

(54) THREE-DIMENSIONAL PRINTING PLASTIC ONTO METAL

(71) Applicant: Apple Inc., Cupertino, CA (US)

(72) Inventors: Simon Regis Louis LANCASTER-LAROCQUE, San Jose, CA (US); Robert Y. CAO, San Francisco, CA (US); Francesco H. TROGU, San Francisco, CA (US)

(21) Appl. No.: 15/271,183

(22) Filed: Sep. 20, 2016

Related U.S. Application Data
(60) Provisional application No. 62/233,694, filed on Sep. 28, 2015.

(51) Int. Cl. B29C 67/00

(52) U.S. Cl. CPC B29C 67/0066; B33Y 10/00

(57) ABSTRACT

A three-dimensional printing system includes a reservoir containing a UV curable resin therein, a UV light, an oxygen delivery system, and a movable platform having a build surface configured to support a three-dimensional printed part at a non-planar feature thereon. The bottom of the reservoir can be UV-transparent and oxygen permeable, so the resin is cured by UV light at the build surface or printing part, but not cured despite UV light at the oxygen rich region near the reservoir bottom. Non-planar features include recesses and/or protrusions at the build surface, which can help form backsides of printed parts. Metal parts can be fitted to non-planar features to have thin insulative three-dimensional layers printed thereto. Many identical non-planar features can be used to mass-produce identical printed parts, which can be for electronic devices.

### CROSS-REFERENCE TO RELATED APPLICATION

This application claims the benefit of U.S. Provisional Patent Application No. 62/233,694, filed on Sep. 28, 2015, which is incorporated by reference herein in its entirety for all purposes.

### FIELD

The described embodiments relate generally to additive manufacturing. More particularly, the described embodiments relate to three-dimensional printing of various materials onto metal components during a manufacturing process.

### BACKGROUND

Three-dimensional printing has become increasingly popular in recent years. Various techniques for printing three-dimensional objects can include using a selective printer, projector, lithographic equipment, or the like to print or form layer upon layer in order to build up a three-dimensional object. In some arrangements, a curable resin or other liquid can be hardened layer by layer in a series of set patterns up against a platform surface. This can involve a liquid that is curable using ultraviolet (“UV”) light, for example, which light can be shone or projected in varying and controlled patterns for a specific period of time for each separate layer. This kind of process typically involves separate steps for part movement and stoppage, resin renewal, and UV exposure for each printed layer. Unfortunately, this process can be very time consuming, often taking many hours to print a single three-dimensional object. In addition, the constant starting and stopping in moving the part often leads to visibly discernable layers along the object surface instead of a smooth and continuous surface finish.

While three-dimensional printing processes using are known to have worked well in the past, there can be room for improvement. Accordingly, there is a need for improved systems and methods that print three-dimensional objects having smoother surface finishes and in shorter amounts of time.

### SUMMARY

Representative embodiments set forth herein disclose various structures, methods, and features thereof for the disclosed three-dimensional printing systems. In particular, the disclosed embodiments set forth systems and methods for the rapid printing of three-dimensional parts and other items, such as plastic parts for electronic devices.

According to various embodiments, the disclosed three-dimensional printing systems and methods can involve a fast and continuous process to make detailed three-dimensional parts. An exemplary three-dimensional printing system can include at least: 1) a reservoir containing a curable liquid, 2) a curing component, 3) a gas delivery system, and 4) a platform having a build surface with a non-planar feature. The non-planar feature can be a recess or protrusion that can be used to help form the backside of a three-dimensional printed part or object.

In various embodiments, a printing system includes a reservoir containing a UV curable resin, a UV light, an oxygen delivery system, and a movable platform having a build surface with non-planar feature thereon. The bottom of the reservoir can be UV-transparent and oxygen permeable, such that the resin is cured by UV light at the build surface or printing part, but not cured despite UV light at the oxygen rich region near the reservoir bottom. The printed parts or objects can be plastic printed onto metal. Metal parts can be fitted to non-planar features at the build surface to have thin insulative three-dimensional layers printed thereto. Many non-planar features can be used to mass-produce printed parts, which can be for electronic devices.

This Summary is provided merely for purposes of summarizing some example embodiments so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described will become apparent from the following Detailed Description, Figures, and Claims.

Other aspects and advantages of the embodiments described herein will become apparent from the following detailed description taken in conjunction with the accompanying drawings which illustrate, by way of example, the principles of the described embodiments.

### BRIEF DESCRIPTION OF THE DRAWINGS

The included drawings are for illustrative purposes and serve only to provide examples of possible structures and methods for the disclosed three-dimensional printing systems. These drawings in no way limit any changes in form and detail that may be made to the embodiments by one skilled in the art without departing from the spirit and scope of the embodiments. The embodiments will be readily understood by the following detailed description in conjunction with the accompanying drawings, wherein like reference numerals designate like structural elements.

FIG. 1A illustrates in front perspective view an exemplary three-dimensional printing system in a pre-printing configuration.

FIG. 1B illustrates in illustrates in front perspective view the exemplary three-dimensional printing system of FIG. 1A in a printing configuration.

FIG. 2A illustrates in front perspective view an alternative three-dimensional printing system having non-planar features in a pre-printing configuration according to various embodiments of the present invention.

FIG. 2B illustrates in front perspective view the alternative three-dimensional printing system having non-planar features in a printing configuration according to various embodiments of the present invention.

FIG. 3A illustrates in side cross-sectional view a close up of the platform build surface having non-planar features of FIG. 2B after printing according to various embodiments of the present invention.

FIG. 3B illustrates in side elevation view the printed parts of FIG. 3A after removal from the platform according to various embodiments of the present invention.

FIG. 3C illustrates in side cross-sectional view an alternative platform build surface having a non-planar feature and a metal part fitted thereto in a pre-printing configuration according to various embodiments of the present invention.

FIG. 3D illustrates in side cross-sectional view the platform surface having a non-planar feature and fitted metal part of FIG. 3C after printing according to various embodiments of the present invention.

FIG. 3E illustrates in side cross-sectional view the printed to metal part after removal from the platform according to various embodiments of the present invention.

FIG. 4A illustrates in bottom perspective view an alternative platform build surface having a plurality of identical non-planar features and parts printed thereto according to various embodiments of the present invention.

FIG. 4B illustrates in side cross-sectional plus bottom perspective view the alternative platform build surface of FIG. 4A according to various embodiments of the present invention.

FIG. 4C illustrates in bottom perspective view another alternative platform build surface having non-planar features according to various embodiments of the present invention.

FIG. 4D illustrates in side-cross sectional view the alternative platform build surface of FIG. 4C having a three-dimensional printing performed thereto according to various embodiments of the present invention.

FIG. 5 illustrates a flowchart of an exemplary method for printing a three-dimensional part according to various embodiments of the present disclosure.

FIG. 6 illustrates in block diagram format an exemplary computing device that can be used to implement the various components and techniques described herein according to various embodiments of the present disclosure.

### DETAILED DESCRIPTION

Three-dimensional printing has become increasingly popular. This is a recent development, however, which often results in very long print times and rough surface finishes for many three-dimensional printed objects. Ways to print three-dimensional objects quickly and smoothly are desirable then. It would also be useful to be able to print various plastic components for a manufacturing process using three-dimensional printing techniques, with printing to metal being preferable in some situations.

In various embodiments, a three-dimensional printing system can include a reservoir containing a curable liquid, a curing component, a gas delivery system, and a platform having a build surface with one or more non-planar features. The non-planar feature(s) can be recesses and/or protrusions usable to form the backside of three-dimensional printed parts or objects. The liquid to form the parts or other objects can be a UV curable resin, and the curing component(s) can include UV light(s). The gas delivery system can deliver oxygen into a region of the resin within the reservoir, such as by using a reservoir bottom that is UV-transparent and permeable to oxygen. The platform can be movable as the printed part(s) and/or object(s) are being formed, such as by lifting the platform and build surface out of the resin during printing.

In various embodiments, the platform can be continuously moved, rather than in a start and stop fashion. This can be due to the creation of a “dead zone” in the resin where UV light does not cure the resin well to the presence of oxygen. Curing takes place beyond this oxygen rich dead zone. The printed parts can be plastic printed onto metal. The metal can be the build surface itself and/or one or more metal parts that can be fitted to non-planar features at the build surface, such as to have thin insulative three-dimensional layers printed thereto. Many non-planar features on a given build surface can be used to mass-produce printed parts, which can be for electronic devices. The features and printed parts can be identical in such mass printings.

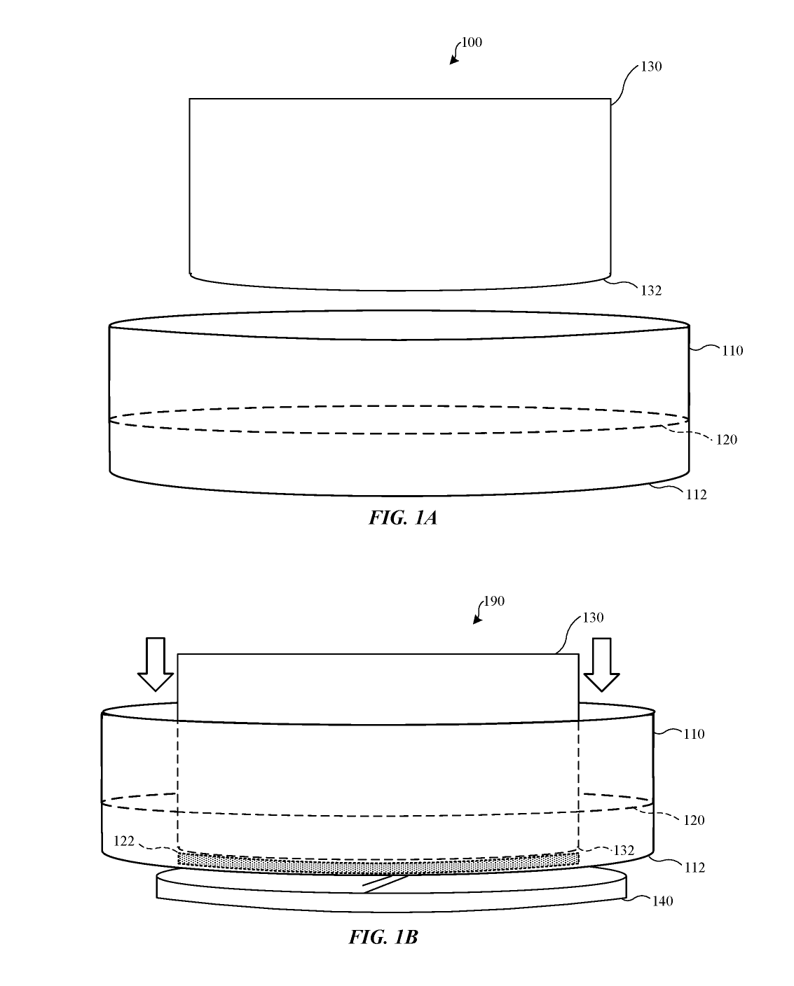

The foregoing approaches provide various structures and methods for the disclosed three-dimensional printing systems. A more detailed discussion of these structures, methods, and features thereof is set forth below and described in conjunction with FIGS. 1-6, which illustrate detailed diagrams of devices and components that can be used to implement these structures, methods, and features.

Turning first to FIG. 1A, an exemplary three-dimensional printing system is shown in a pre-printing configuration in front perspective view. System 100 can include a reservoir 110 that contains a curable liquid, such as resin 120. The resin 120 can cure or harden when exposed to UV light, which can be provided through a window at or the entire bottom 112 of reservoir 110, for example. This window or entire bottom 112 of reservoir 110 can be glass, hard plastic, or any other suitable material that can hold a curable resin and also allow UV light to pass therethrough. A platform 130 having a flat or planar build surface 132 can be positioned above the reservoir 110 prior to printing. The platform can be configured to support a printed object at build surface 132, and can also be configured to move up and down, into and out of the resin 120 within reservoir 110.

FIG. 1B illustrates in illustrates in front perspective view the exemplary three-dimensional printing system of FIG. 1A in a printing configuration. Printing configuration 190 depicts the platform 130 having been lowered into the reservoir 110 such that build surface 132 is fully within the resin 120. In various embodiments, platform 130 can be lowered into the curable resin 120 within reservoir 110 down to a distance between build surface 132 and bottom 112 of reservoir 110 that is minimal. This can be the typical thickness of the cure layer, for example, which can be about 20-30 microns, such as 25 microns. A UV light source 140 beneath the reservoir 110 can be arranged to shine or project UV light through the bottom 112 of the reservoir 110. This UV light source 140 can shine or project UV light images in an automated fashion for various time intervals in order to facilitate curing or “printing” of the resin to the build surface 132, as will be readily appreciated by one of skill in the art.

Unlike other UV-curable resin based three-dimensional printing processes that require moving the platform or other similar supporting component in a start and stop manner, system 100 can print while moving platform 130 in a continuous steady fashion. Although a UV-curable resin ordinarily tends to cure or harden in the presence of UV light, this can be significantly hampered by infusing the resin with a reactive gas such as oxygen where curing or hardening is not desired. When present, oxygen reacts with the polymerizing chains in the resin, which significantly slows down the curing (i.e. printing) reaction. Accordingly, the bottom 112 of the reservoir 110 (or a suitable window or portion thereof) may be permeable to oxygen, such that the content and flow of oxygen into the resin 120 can be controlled to prevent curing at certain locations despite the presence of UV light. Bottom surface 112 can be formed from various models of Teflon, for example, which can be both UV transparent and have excellent oxygen permeability.

A gap or zone such as “dead zone” 122 shows the amount of resin 120 that is between the flat or planar build surface 132 of the platform 130 and the inner surface at the bottom 112 of the reservoir 110. In some embodiments, this dead zone 122 provides a region where curing or hardening of the resin 120 does not take place despite the presence of UV light. Such a dead zone 122 can then allow for a continuous movement upward of platform 130 during the actual printing process, since there is more space for resin 120 to continuously flow beneath the build surface 132 but without curing, so as to facilitate continuous printing.

Outside of the dead zone 122, such as at the build surface 132 itself, the UV light then cures or hardens the resin 120. This distance can be controlled such that curing takes place at the build surface 132 and/or on top of a currently printing object, for example. This allows for a constant renewal of curable liquid resin 120 to that the part is built from, with the liquid resin flowing into the dead zone 122 as the platform 130 is continuously moved upward and out of the reservoir 110. The resulting parts or objects are printed relatively quickly and continuously, and also have smooth surfaces rather than the layered surface lines typically associated with three-dimensional printing. Although printing using a UV-curable resin and lithographic type process is being presented for illustrative purposes, it will be readily appreciated that other types of printing and equipment may also be used, such as, for example, a selective laser printer, projector, various masks, and so forth.

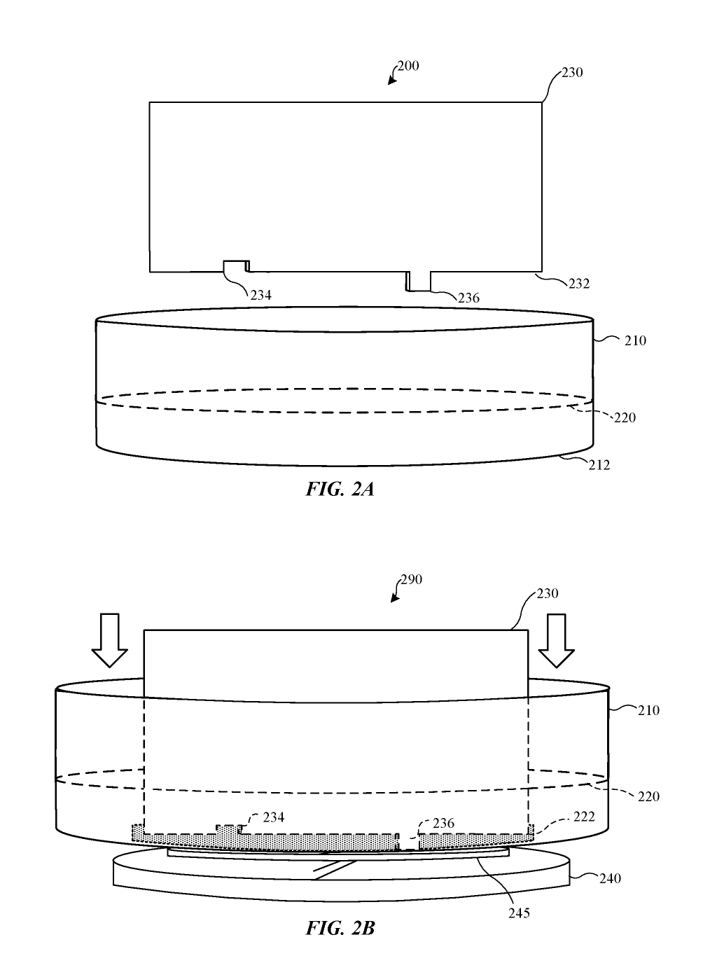

Turning next to FIG. 2A, an alternative three-dimensional printing system having non-planar features in a pre-printing configuration is illustrated in front perspective view. Three-dimensional printing system 200 can similarly include a reservoir 210 that contains a curable liquid, such as resin 220. Again, the resin 220 can cure or harden when exposed to UV light, which can be provided through bottom 212 of reservoir 210. A platform 230 having a build surface 232 can be positioned above the reservoir 210 prior to printing. Again, the platform 230 can be configured to support a printed object at build surface 232, and can also be configured to move up and down, into and out of the resin 220 within reservoir 210.

Unlike the previous system 100, however, build surface 232 is not fully planar in nature. Rather, build surface 232 can have one or more non-planar features, such as a three-dimensional recess 234 and/or a three-dimensional protrusion 236. In various embodiments, a given build surface 232 can have multiple recesses 234 and/or protrusions 236, each of which may or may not have different three-dimensional profiles. In general, a recess 234 provides a three-dimensional surface to be filled by cured resin during a printing process, while a protrusion 236 provides a three-dimensional surface to be printed onto during the printing process. By providing these non-planar features to be printed to rather than a simple flat or planar build surface, various advantages can be realized. For example, additional temporary supports for the contoured backside of a sphere or other three-dimensional object are not needed, fewer printing production steps are not required, and time can be conserved with respect to printing various three-dimensional parts or objects.

FIG. 2B illustrates in front perspective view the alternative three-dimensional printing system having non-planar features in a printing configuration according to various embodiments of the present invention. Printing configuration 290 similarly depicts the platform 230 having been lowered into the reservoir 210 such that build surface 232 is fully within the resin 220. In various embodiments, platform 230 can be lowered into the curable resin 220 to a distance between build surface 232 and the inner surface at the bottom 212 of reservoir 210 that is minimal, such as about 20-30 microns. A UV light source 240 beneath the reservoir 210 can be arranged to shine or project UV light through the bottom 212 of the reservoir 210. Also, a gas delivery system 245 can be arranged to provide gas into the resin 220 through a permeable wall or bottom of the reservoir 210. Again, this can be oxygen, which can be provided through an oxygen permeable bottom 212 of reservoir 210. By controlling the oxygen content provided therethrough, a dead zone 222 can be created where resin is not cured or hardened despite exposure to UV light from UV light source 240. Again, this dead zone 222 can be located between the build surface 232 and the inner surface at the bottom 212 of reservoir 210. Although the reservoir bottom 212 has been referenced as a boundary for the dead zone 222, it will be readily appreciated that such a boundary could also be a reservoir wall, such as where a reservoir wall (or a window or portion thereof) is permeable to the gas and is also transparent or translucent to UV light or another curing source.

As the platform 230 is then moved upward and out of the resin 220 during the printing process, resin that is outside of the dead zone 222 can then be cured or printed onto the build surface 232 as this surface exits the dead zone. Because the build surface has one or more non-planar features, such as recess 234 and protrusion 236, printing to these surfaces may take place at different times across each surface, due to their three-dimensional natures and different times of exiting the dead zone 222. The dead zone 222 can be varied by changing the oxygen content therewithin, such as by providing more oxygen and/or greater pressures of oxygen. Also, different heights across the build surface 232 can be printed to, due to the presence of the dead zone 222, as will be readily appreciated. Although a non-planar feature on the build surface may have a particular three-dimensional shape, it will be readily appreciated that this shape is merely used as a starting point or foundation for printing a given three-dimensional part or object. The full size and shape of each three-dimensional object can vary as desired based upon the build properties of the ongoing three-dimensional printing. For example, recess 234 might be used for one build to create a part that simply fills the recess 234, like a simple mold. Recess 234 might then be used for another build to create a different part that fills the recess 234 and then builds upon it to form a larger part, such as a plastic foot for an electronic device, as illustrated below.

Platform 230 can be formed from aluminum, anodized aluminum, aluminum alloy, or any other suitable material. In some embodiments, platform 230 can be a reusable part of a given three-dimensional printing system 200, such that many separate three-dimensional printings can be made using the same platform 230. In some embodiments, platform 230 can be a part of a final three-dimensional printed product, such that platform 230 can be removed from the system 200 with the three-dimensional items printed thereto at the end of a given printing. Accordingly, platform 230 can be removable from the remainder of a given system 200. For example, platform 230 can be an anodized aluminum component having one or more cured items three-dimensionally printed thereto, all of which combine to form a finished compound part. In various embodiments, platform 230 may be reused for multiple different three-dimensional printings, and can then be removed with items printed thereto after a final printing. Platform 230 may also be removable as a reusable part in a given system 200, such as where different platforms with different non-planar or three-dimensional features can be interchangeably used to print different three-dimensional items using the same system 200.

In various embodiments, properties of the resin 220 can be controlled or adjusted in order to favorably alter a three-dimensional printing process. For example, the thickness or depth of a print layer can be increased where resin 220 has a greater transmissivity to light. As such, resin 220 can be a clear curable polymer where a maximum thickness is desired for the print layers of a given printing process. Conversely, a more opaque polymer can be used for resin 220 where thinner print layers are desired. Thickness of the print layers can affect various aspects of a three-dimensional printing process. For example, overall print times might be decreased where fewer overall layers are printed due to greater average layer thicknesses. Alternatively, initial and secondary cure times might be decreased where thinner layers are printed. Various print layer details may also be better controlled by varying the thickness or depth of the print layers.

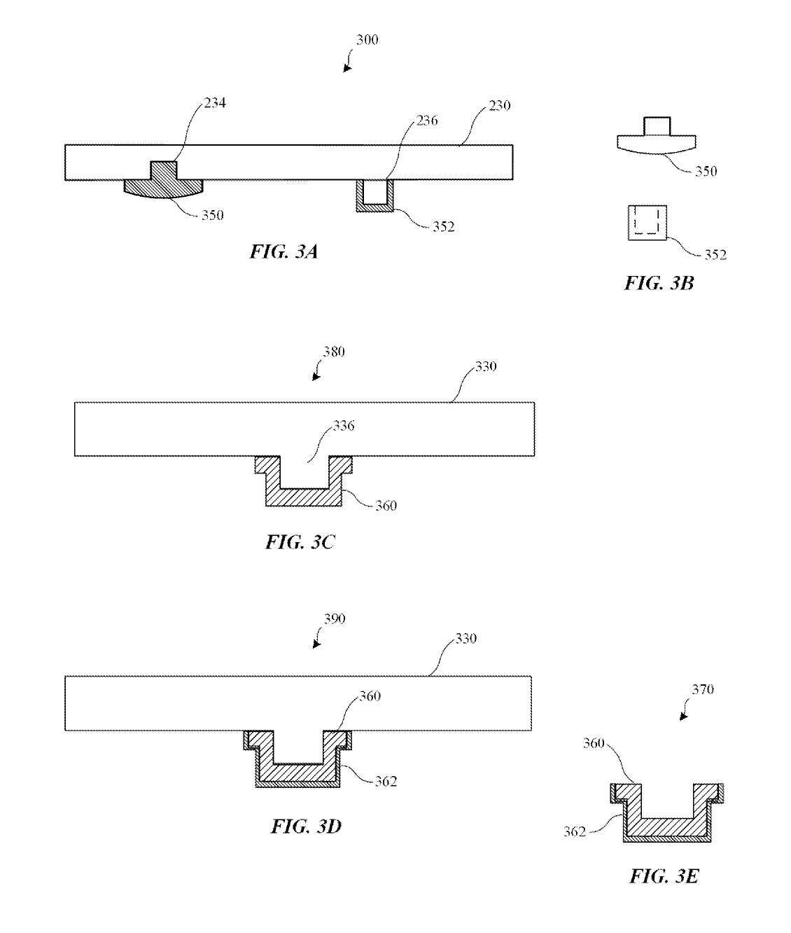

FIG. 3A illustrates in side cross-sectional view a close up of the platform build surface having non-planar features of FIG. 2B after printing according to various embodiments of the present invention. Arrangement 300 shows one possible result after printing to the foregoing platform 230 having a recess 234 and a protrusion 236. As shown, a plastic foot 350 for an electronic device has been printed into and on top of recess 234, while a simple plastic open cap or cylinder has been printed atop protrusion 236. As will be readily appreciated, the plastic foot 350 can be printed first by filling the recess volume with cured or printed resin, and then continuing to print on top of this recess volume, as well as atop the build surface, to arrive at the finally formed part. This can take place as the platform 230 continuously rises or moves during the overall printing process. Other regions, parts, or components can be printed at the same time as any portion of plastic foot 350 is being printed, as controlled by the projected UV patterns.

FIG. 3B illustrates in side elevation view the printed parts of FIG. 3A after removal from the platform 230. Plastic foot 350 and plastic cap 352 have been removed from recess 234 and protrusion 236 respectively, which removal can take place in any number of ways. These parts may be popped off or out of their respective non-planar features, or they may be cut out, vacuum hold released, removed via designed perforations or precuts, or any other suitable way. In various embodiments, one or more non-planar features or portions thereof, as well as one or more other surface portions on build surface 232 may be designed for better hold or better removal, such as by way of a smooth or rough polish or surface finish, for example. Rougher surfaces would have better adhesion and make some parts or portions thereof more difficult to remove, while smoother surfaces would have weaker adhesion and make removal easier.

FIG. 3C illustrates in side cross-sectional view an alternative platform build surface having a non-planar feature and a metal part fitted thereto in a pre-printing configuration according to various embodiments of the present invention. Arrangement 380 shows an alternative platform 330 having a protrusion 336 formed thereupon. A metal part 360 can be fitted onto the protrusion 336 as shown. It will also be appreciated that a different size or shape for the protrusion 336 could be used depending upon the geometry of metal part 360, and that a recess might be a more appropriate shape for some metal parts. Arrangement 380 can be used where it is desirable for a particular metal part to have a thin insulative layer, for example. Other reasons to print onto a metal part may also work for printing to a metal part in this manner. Metal part 360 may be formed by another process prior to being fitted onto protrusion 336 for a separate plastic to metal printing. For example, metal part 360 might be precut with its own various features using a CNC or other tooling.

FIG. 3D illustrates in side cross-sectional view the platform surface having a non-planar feature and fitted metal part of FIG. 3C after printing according to various embodiments of the present invention. Arrangement 390 shows the platform 330 and metal part 360 fitted thereto after a thin insulative layer 362 has been printed and cured onto the metal part 360. Such a layer can be an insulative plastic or dielectric. FIG. 3E illustrates in side cross-sectional view the printed to metal part after removal from the platform 330. Printed part 370 includes the original metal part 360 and the thin printed layer 362, and can be used as a single part formed from different materials. The insulative layer can be, for example, about 1 mm thick, which would represent a thickness that is too small to injection mold or form via other ways.

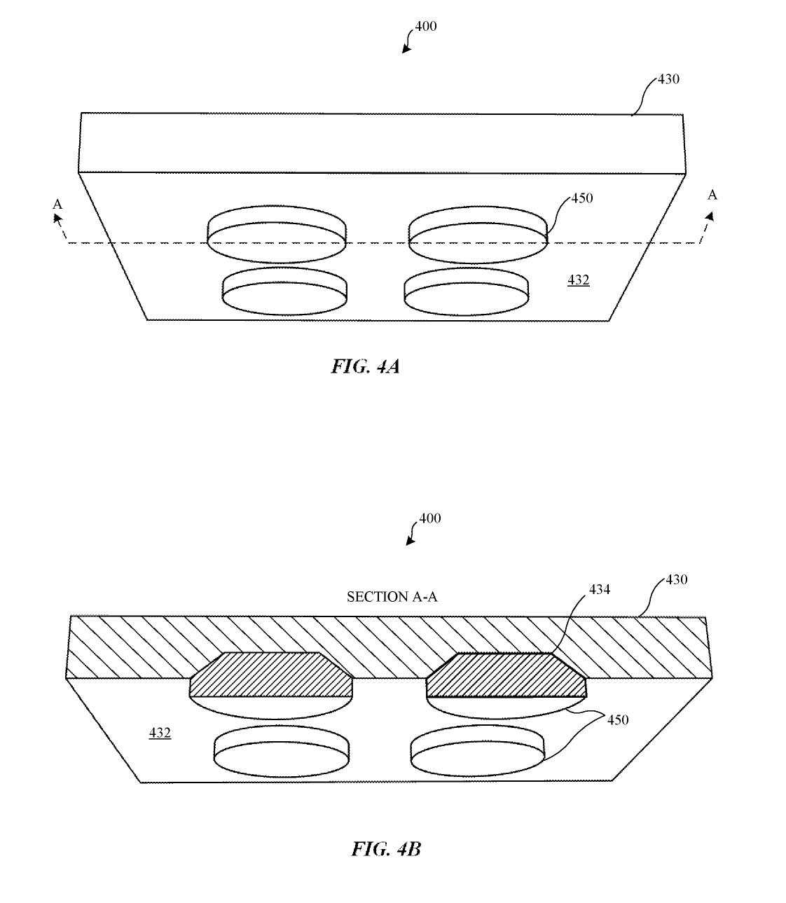

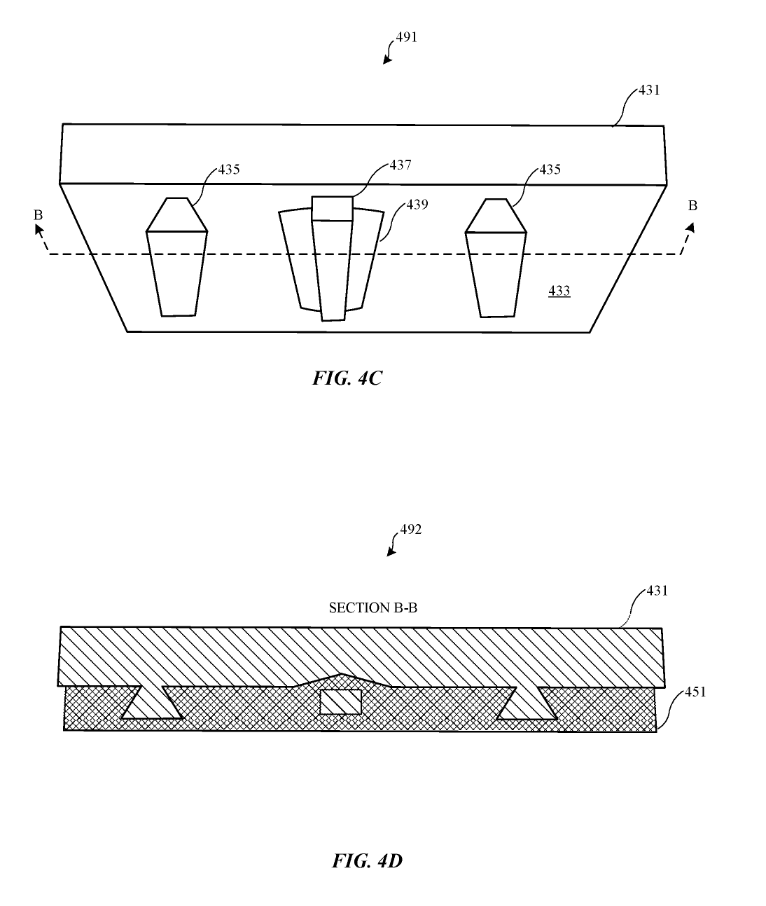

Moving to FIGS. 4A and 4B, an alternative platform build surface having a plurality of identical non-planar features and parts printed thereto is illustrated in bottom perspective and side cross-sectional plus bottom perspective views respectively. Arrangement 400 can include a platform 430 having a build surface 432 designed for printing a plurality of identical or similar parts, such as plastic feet 450 for a laptop or other computing device. As shown at section A-A, each plastic foot 450 can be formed within a recess 434 within build surface 432, while also having a built up portion that extends above the build surface 432. Although only four plastic feet 450 are shown, it will be readily appreciated that a given platform 430 may have many more identical recesses and/or other non-planar features for such parts. For example, a given platform may have dozens or even hundreds of recesses or protrusions, such that dozens or hundreds of parts may be printed at the same time during the manufacture of many items, such as electronic device parts. Again, platform 430 may be reusable in order to create multiple different printed items in multiple separate printing procedures, or platform 430 may be part of a finished compound part such that it is removed from arrangement 400 with items printed thereto at the end of a given printing.

In various embodiments, one or more added steps or items may be implemented in order to effect increased or decreased adhesion between a given build surface and the item or items being three-dimensionally printed thereto. As noted above, a given platform can be formed from aluminum, while various three-dimensionally printed items can be formed from a hardened resin, such as a UV-cured polymer. Of course, other suitable materials may also be used as may be desired. In some embodiments, an additional intermediate item may be placed between the platform and the hardened resin, such as in FIGS. 3C-3E shown above. Such an additional item can be formed from aluminum, anodized aluminum, aluminum alloy, steel, or any other suitable material. Improved adhesion may be desired between the three-dimensionally printed items and the platform or intermediate item to which the three-dimensionally printed items are printed. This can be the case where a final compound product is being created, such that a permanent bond is desired between the different material components, for example.

Increased adhesion can thus be effected between printed items and the component having the surface to which the printed items are printed. This can involve creating a rougher print or build surface on the platform or intermediate item, for example. In some embodiments, a given build surface can be primed to have a rougher surface finish or texture. Alternatively, or in addition, various physical interlocks might be implemented at a build surface. These can include, for example, one or more grooves, dovetails, undercuts, through holes, and the like. In some embodiments, a platform or other intermediate item that is to have an anodized finish might not be anodized at the actual build surface where three-dimensional items are printed. This can be accomplished by selective anodization or removing the anodized surface finish at the build surface. Such a non-anodized finish at the build surface might then promote better adhesion for a greater permanent bond between printed item(s) and the platform or other intermediate item.

Continuing with FIGS. 4C and 4D, another alternative platform build surface having non-planar features is shown in bottom perspective view, and this alternative platform build surface having a three-dimensional printing performed thereto is then shown in side cross-sectional view. Arrangement 491 can include alternative platform 431 having a build surface 433 designed for printing various non-planar features. Such non-planar features can include one or more physical interlock features, such as extended dovetails 435, and an extended protrusion 437 that is situated above a partial undercut 439, for example. Other non-planar features that can serve as physical interlock features might also be used, as will be readily appreciated. As shown at section B-B, a three-dimensional printing 451 has been printed and cured atop the build surface of alternative platform 431. Various portions of three-dimensional printing 451 provide physical interlocks with alternative platform 431, such as near the build surface in the vicinity of the extended dovetails 435 and the extended protrusion 437. Three-dimensional printing 451 may be a single printed layer, or may comprise multiple printed layers. In either event, one or more additional layers may then be printed atop three-dimensional printing 451, as desired.

In various embodiments, some portions of a three-dimensional printing comprising a cured or curable material may be more difficult to print than others. For example, the physical interlock portions of three-dimensional printing 451 above may be relatively difficult to form. Other portions of a three-dimensional printing that may be similarly more complex and/or may not have a direct line of sight with a UV light source or other curing component may also be relatively difficult to form. Various additional system components and/or process steps may be implemented to account for such issues. For example, additional UV light sources or other curing components may be provided, such as through one or more sides of a reservoir holding a curable resin to be printed. Alternatively, or in addition, a separate curing step in an oven or other system component may be used to facilitate a full curing of such regions or portions of curable material that may not have been fully exposed to UV light or another curing source during the active printing process.

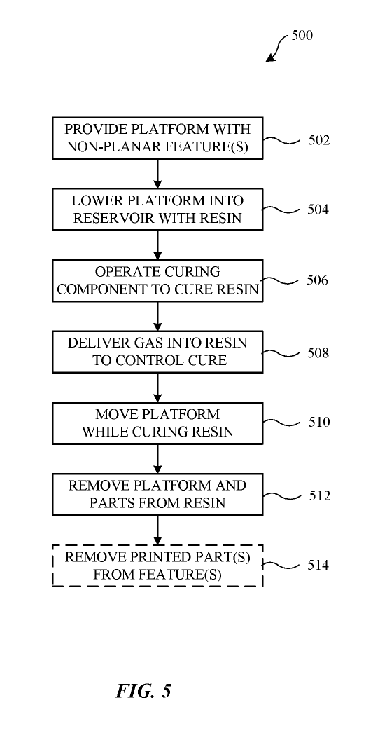

Turning next to FIG. 5, a flowchart of an exemplary method for printing a three-dimensional part is provided. Method 500 can be carried out by one or more processors or other controllers that may be associated with a three-dimensional printing system, such as to control various automated processing components, for example. Method 500 can start at a process step 502, where a platform or other suitable supporting component can be provided. Again, the platform can have a build surface configured to support the three-dimensional part during the three-dimensional printing process. The build surface can include one or more non-planar features thereon, rather than being strictly flat or planar.

At the next process step 504, the platform can be lowered into a reservoir containing a curable liquid. Again, this can be a UV-curable resin, which can be used to print plastic parts as set forth herein. At a following process step 506, a curing component can be operated in a controlled manner in order to print the three-dimensional part. This can be done by curing a first portion of the resin or other curable liquid at the non-planar feature, for example. Further curing can then take place atop already cured resin as the part is printed or formed. At process step 508, a gas can be delivered into the curable liquid in a controlled manner to prevent a second portion of the curable liquid from curing. Again, this can be oxygen delivered into a “dead zone” between the build surface and an inner surface of the reservoir, such as its bottom, or a wall, or both.

At a following process step 510, the platform can be moved while curing the curable liquid in a controlled manner to form the part or component. Moving the platform can be done continuously until the part or component is finished printing in some embodiments. At the next process step 512, the platform and printed parts attached thereto can be completely removed from the resin, after which an optional process step 514 can involve removing the printed part or parts from the non-planar feature or features on the build surface of the platform. In some embodiments, the printed portion is not removed from the platform, such as where the platform forms a portion of a finished compound part. An added step may then involve removing the platform from the rest of the three-dimensional printing system. The process may then be repeated as desired to form additional parts. In the event that the platform is removed, then a step to install a new platform may be added as well.

For the foregoing flowchart, it will be readily appreciated that not every step provided is always necessary, and that further steps not set forth herein may also be included. For example, added steps that involve designing the non-planar feature(s) on the platform may be added. Also, steps that provide more detail with respect to printing on the three-dimensional surface of a feature may also be added. Other steps not include may also involve fitting an existing metal part onto the non-planar feature, such that a thin protective layer can be printed to the separate metal part. Still further steps may include an additional oven curing step, for example. Furthermore, the exact order of steps may be altered as desired, and some steps may be performed simultaneously. For example, steps 506-510 may be performed simultaneously in some embodiments.

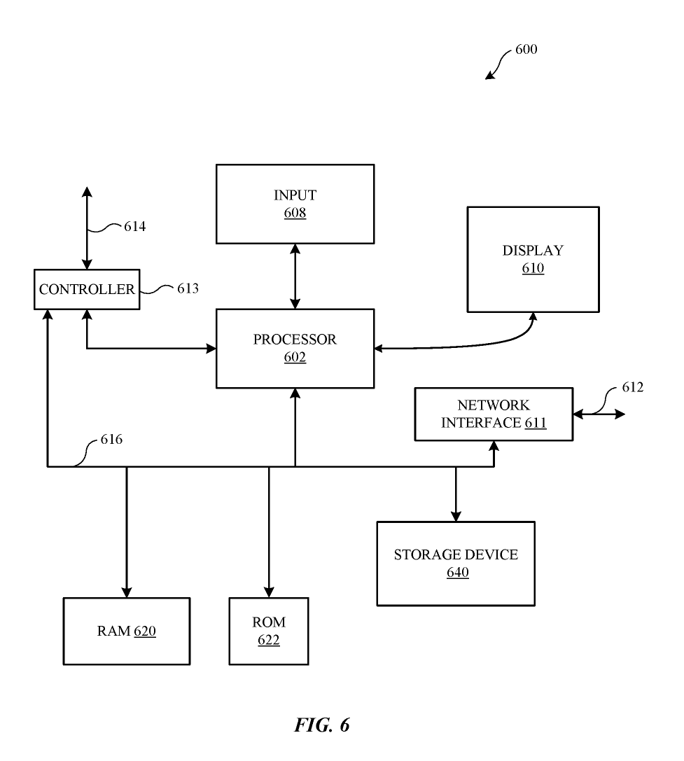

FIG. 6 illustrates in block diagram format an exemplary computing device 600 that can be used to implement the various components and techniques described herein, according to some embodiments. In particular, the detailed view illustrates various components that can be included in an electronic device suitable for an automated three-dimensional printing system, such as that which is shown in FIGS. 1-5. As shown in FIG. 6, the computing device 600 can include a processor 602 that represents a microprocessor or controller for controlling the overall operation of computing device 600. The computing device 600 can also include a user input device 608 that allows a user of the computing device 600 to interact with the computing device 600. For example, the user input device 608 can take a variety of forms, such as a button, keypad, dial, touch screen, audio input interface, visual/image capture input interface, input in the form of other sensor data, etc. Still further, the computing device 600 can include a display 610 (screen display) that can be controlled by the processor 602 to display information to the user (for example, a movie or other AV or media content). A data bus 616 can facilitate data transfer between at least a storage device 640, the processor 602, and a controller 613. The controller 613 can be used to interface with and control different equipment through and equipment control bus 614. The computing device 600 can also include a network/bus interface 611 that couples to a data link 612. In the case of a wireless connection, the network/bus interface 611 can include a wireless transceiver.

The computing device 600 can also include a storage device 640, which can comprise a single disk or a plurality of disks (e.g., hard drives), and includes a storage management module that manages one or more partitions within the storage device 640. In some embodiments, storage device 640 can include flash memory, semiconductor (solid state) memory or the like. The computing device 600 can also include a Random Access Memory (RAM) 620 and a Read-Only Memory (ROM) 622. The ROM 622 can store programs, utilities or processes to be executed in a non-volatile manner. The RAM 620 can provide volatile data storage, and stores instructions related to the operation of the computing device 600.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a computer readable medium. The computer readable medium is any data storage device that can store data which can thereafter be read by a computer system. Examples of the computer readable medium include read-only memory, random-access memory, CD-ROMs, DVDs, magnetic tape, hard disk drives, solid state drives, and optical data storage devices. The computer readable medium can also be distributed over network-coupled computer systems so that the computer readable code is stored and executed in a distributed fashion.

The foregoing description, for purposes of explanation, uses specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

What is claimed is:

1. A three-dimensional printing system, comprising:
a reservoir configured to contain a curable liquid therein;
a curing component configured to cure the curable liquid contained within the reservoir during a three-dimensional printing process;
a gas delivery system configured to provide a gas into a portion of the curable liquid during the three-dimensional printing process; and
a platform having a build surface configured to support a three-dimensional object being printed from the curable liquid during the three-dimensional printing process, wherein the build surface includes one or more non-planar features thereon.

2. The three-dimensional printing system of claim 1, wherein the curable liquid is a resin that is curable by ultraviolet (“UV”) light.

3. The three-dimensional printing system of claim 2, wherein the curing component includes a UV light.

4. The three-dimensional printing system of claim 1, wherein the reservoir includes a bottom portion that is permeable to the gas.

5. The three-dimensional printing system of claim 4, wherein the bottom portion of the reservoir is also transparent to UV light.

6. The three-dimensional printing system of claim 4, wherein the gas is oxygen.

7. The three-dimensional printing system of claim 1, wherein the curable liquid is not readily curable when it contains the gas.

8. The three-dimensional printing system of claim 1, wherein the one or more non-planar features include a three-dimensional recess.

9. The three-dimensional printing system of claim 8, wherein the three-dimensional printing system is configured to form a three-dimensional part for an electronic device from the curable liquid within the three-dimensional recess.

10. The three-dimensional printing system of claim 1, wherein the one or more non-planar features include a three-dimensional protrusion rising from the build surface.

11. The three-dimensional printing system of claim 10, wherein the three-dimensional printing system is configured to form a three-dimensional part for an electronic device from the curable liquid.

12. The three-dimensional printing system of claim 1, wherein the one or more non-planar features include a feature that is configured to receive a metal part for an electronic device.

13. The three-dimensional printing system of claim 12, wherein the three-dimensional printing system is configured to form an insulative layer from the curable liquid on the metal part, the insulative layer having a thickness of about 1 mm or less.

14. The three-dimensional printing system op claim1, wherein the one or more non-planar features comprise a plurality of identical features.

15. A method for printing a three-dimensional part, the method comprising:
providing a platform having a build surface configured to support the three-dimensional part during a three-dimensional printing process, wherein the build surface includes a non-planar feature thereon;
lowering the platform into a reservoir containing a curable liquid;
operating a curing component in a controlled manner to print the three-dimensional part by curing a first portion of the curable liquid at the non-planar feature;
delivering a gas into the curable liquid in a controlled manner to prevent a second portion of the curable liquid from curing, the second portion being located between the build surface and an inner surface of the reservoir; and
moving the platform while operating the curing component in a controlled manner to print the three-dimensional part.

16. The method of claim 15, wherein moving the platform further comprises:
moving the platform continuously during the three-dimensional printing process.

17. The method of claim 15, wherein the platform forms a portion of the three-dimensional part.

18. The method of claim 17, wherein the build surface further includes features that improve adhesion between the build surface and the cured first portion of the curable liquid.

19. An electronic device comprising:
an outer housing containing one or more electronic processing components therein; and
a three-dimensional part contained within or coupled to the outer housing, the three-dimensional part including an insulative layer formed on a metal portion, wherein the insulative layer has a thickness of 1 mm or less.

20. The electronic device of claim 19, wherein the insulative layer comprises a resin that is printed and cured onto the metal portion.
